(19) United States
(12) Patent Application Publication
(10) Pub. No.: US 2014/0241741 A1
(43) Pub. Date: Aug. 28, 2014

(54) CORRECTION CONTROL METHOD AND IMAGE FORMING APPARATUS

(71) Applicants: Makoto Komatsu, Kanagawa (JP); Shinji Kato, Kanagawa (JP)

(72) Inventors: Makoto Komatsu, Kanagawa (JP); Shinji Kato, Kanagawa (JP)

(21) Appl. No.: 14/167,100

(22) Filed: Jan. 29, 2014

(30) Foreign Application Priority Data
Feb. 28, 2013 (JP) 2013-038645

(51) Int. Cl. G03G 15/00; G03G 15/16; G03G 15/08

(52) U.S. Cl. CPC G03G 15/0824
USPC 399/38; 399/66; 399/58

(57) ABSTRACT

A correction control method includes performing correction control to bring a control value to a target value or a change through a prediction control system that previously applies a predetermined amount of correction and a predetermined timing. The prediction control system is constructed without performing data offset processing for deriving the predetermined amount of correction and the predetermined timing.

### CROSS-REFERENCE TO RELATED APPLICATION

The present application claims priority to and incorporates by reference the entire contents of Japanese Patent Application No. 2013-038645 filed in Japan on Feb. 28, 2013.

### BACKGROUND OF THE INVENTION

1. Field of the Invention

The present invention relates to a correction control method and an image forming apparatus using the correction control method.

2. Description of the Related Art

Image forming apparatuses, such as a multifunction peripheral, having at least two of the functions of copier, printer, and facsimile machine perform toner concentration control to have a preferable toner concentration by keeping the balance between consumption and supply of toner in order to keep the image quality preferable. For example, Japanese Patent Application Laid-open No. 2008-299315 discloses a configuration where, in order to keep constant the toner concentration in a developing device, prediction data indicating variations in the toner concentration of a developer over time is calculated and a toner supply operation is performed according to the prediction data.

Regarding keeping constant the toner concentration in a developing device, when each of supply and consumption operations are considered, for example, with respect to supply, once the supply operation is performed, the toner remains in the developing device. With respect to the consumption, once the toner in the developing device is consumed, the toner goes out of the developing device and never returns. In other words, it can be considered that the toner concentration in the developing device has a function equivalent to integration in order to keep the previous sate.

When the toner concentration control is constructed by using a feedback (FB) control system that corrects deviation after measurement, correction control cannot be performed until deviation occurs and thus the image quality lowers while the deviation is occurring. For this reason, the toner concentration control is preferably constructed by using a feedforward (FF) control system. When a normal FF control system is constructed, offset processing is performed in general on the measurement data illustrated in FIG. 16 in order to extract variation components from the measurement data so that the variation components are simplified as illustrated in FIG. 17.

Such offset processing is also performed on toner stuck data and transfer rate data. Specifically, for the amount of toner stuck and the transfer rate, an FF control system is constructed where offset processing is performed on the measurement data illustrated in FIG. 19 and FIG. 21 in order to extract variation components from the measurement data so that the variation components are simplified as illustrated in FIG. 20 and FIG. 22.

There is a tendency that, as the value of the toner concentration sensor output increases, in opposite, the toner concentration decreases. This is because a method is widely used where the toner concentration is measured not directly from a developer consisting of toner and carriers but indirectly by using magnetic permeability of the carriers that are magnetic substance. Although the details of the principle of detection will be omitted, the relationship between the toner concentration sensor output and the toner concentration is as illustrated in FIG. 18.

With respect to the graph of the offset measurement data, each of the toner supply and consumption operations will be considered first. For example, for example, for positive values in the supply operation, it can be determined that supply is necessary, and, for negative values, it is determined that negative supply is necessary, which has however no physical meaning. For example, it is not problematic if it is possible to perform the consumption operation for negative values, but consumption should be performed by users and, in principle, should not be performed by the designer.

Even for offset measurement data, an FF control system can be constructed with recent developed computing ability because computational algorithms using a computer have nothing to do with laws of physics and thus such laws may be ignored and processing, such as, interpolation or correction is automatically performed to lead to an answer. While automatic correction of few errors without designer's consciousness is the helpful ability, such operations are not preferable for the toner concentration control, which leads to a problem in that an undesirable operation may be performed under various circumstances in some cases.

In toner concentration control employed in present products, because errors corresponding to unintended operations are integrally accumulated, such errors are removed by treating them as errors in an FF control system and by using an FB control system together.

If the accuracy of the FF control system increases, the FB control system can greatly fulfill its potential in other functions, such as following potential for a case where the target value varies, which is a preferable configuration for overall toner concentration control.

We thus considered that, before a system identification algorithm is applied to system input/output data that is acquired by using a proper sampling period, it is necessary to process or adjust such signals such that the potential of the identification algorithm can be fulfilled at maximum. Specifically, because disturbance, such as drift, offset, and trend, existing in a lower frequency band is not preferable for system identification, it is necessary to remove the effects of the disturbance from the input/output data.

However, depending on the processing contents, physical meaning may be canceled or physically meaningless features may be created.

Here, particularly, removal of offsets is focused. For methods of removing offsets, there are a method using a deviation from the dynamic equilibrium point, a method of reducing offsets from the data of the sample mean value.

For pre-processing for system identification, a comparison is made between the result of constructing a model using the data obtained by removing offsets from raw input/output data and the result of constructing a model by using data from which offsets has not been removed.

For a stable system, an accurate model can be obtained regardless whether offsets are removed. However, it appears that, for a system including an integrator, modeling fails due to removal of offsets.

There is a need to provide a correction control method with a physical meaning, i.e., where the measurement data is used without performing offset processing and an image forming apparatus using the correction control method for toner supply control.

### SUMMARY OF THE INVENTION

It is an object of the present invention to at least partially solve the problems in the conventional technology.

According to an embodiment, there is provided a correction control method that includes performing correction control to bring a control value to a target value or a change through a prediction control system that previously applies a predetermined amount of correction and a predetermined timing. The prediction control system is constructed without performing data offset processing for deriving the predetermined amount of correction and the predetermined timing.

According to another embodiment, there is provided an image forming apparatus in which the correction control method according to the above embodiment is performed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts a schematic configuration of an image forming apparatus according to an embodiment of the present invention;

FIG. 2 is a flowchart indicating the flow of control where the present invention is carried out for the image forming apparatus illustrated in FIG. 1;

FIG. 3 depicts a developing unit configuration in the vicinity of a developer circulation route in which a developer consisting of two components circulates in a developing unit;

FIG. 4 is a graph indicating supply basic patterns for a toner supply device;

FIG. 5 is a graph illustrating how to cancel unevenness in the toner concentration by using supply basic waveforms for a unit consumption waveform that occurs due to some image output;

FIG. 6 is a graph indicating how the toner concentration sensor output behaves when toner concentration variations are detected;

FIG. 7 is a graph indicating how the toner concentration sensor output behaves when toner concentration variations are detected;

FIG. 8 illustrates graphs indicating a case where toner is supplied and a case where toner is not supplied;

FIG. 9 is a graph indicating the correlation of the amount of toner stuck with respect to the LD power or the value of developing bias;

FIG. 10 is a graph indicating the correlation between the amount of toner stuck and the LD power or the developing bias;

FIG. 11 is a graph indicating the relationship between a certain amount of toner stuck, the LD power, and the developing bias;

FIG. 12 is a graph representing a section used to determine the value of the current to be applied in an actual device;

FIG. 13 is a graph indicating the correlation between the transfer ratio and the applied current;

FIG. 14 is a graph indicating the relationship between the transfer ratio and the applied current at a certain transfer ratio;

FIG. 15 is a graph indicating the relationship between the transfer ratio and the applied current at a certain transfer ratio;

FIG. 16 is a graph indicating the transition of measurement data with respect to the toner concentration sensor output;

FIG. 17 is a graph indicating the measurement data, to which offset processing has been performed, with respect to the toner concentration sensor output;

FIG. 18 is a graph indicating the relationship between the toner concentration sensor output and the toner concentration;

FIG. 19 is a graph indicating the transition of measurement data with respect to the amount of toner stuck;

FIG. 20 is a graph indicating the measurement data, to which offset processing has been performed, with respect to the toner concentration sensor output;

FIG. 21 is a graph indicating the transition of the measurement data with respect to the transfer ratio; and

FIG. 22 is a graph indicating the measurement data, on which offset processing has been performed, with respect to the transfer ratio.

### DETAILED DESCRIPTION OF THE PREFERRED EMBODIMENTS

Embodiments of the present invention will be described with reference to the accompanying drawings.

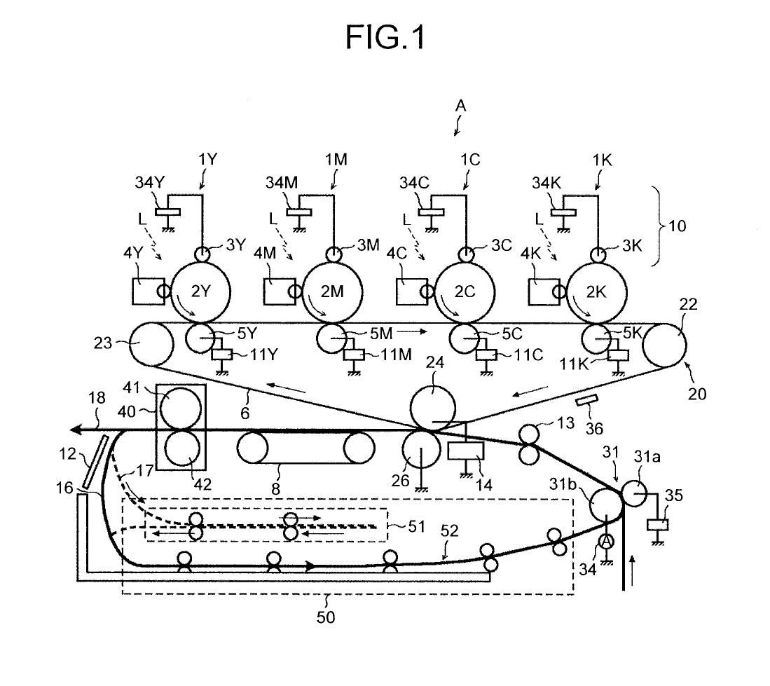

FIG. 1 depicts a schematic configuration of an image forming apparatus according to an embodiment of the present invention.

An embodiment will be described where the present invention is applied to a color printer (hereinafter, simply “printer”) in which a tandem image forming unit serving as an image forming apparatus forms a color image. First, a basic configuration of the printer according to the embodiment will be described. Printer A of the embodiment includes optical writing units (not illustrated), a tandem image forming unit 10, a transfer unit 20, a fixing device 40, and a re-transfer device 50. The tandem image forming unit 10 includes four image forming units 1Y, 1M, 1C, and 1K for forming toner images of Y (yellow), M (magenta), C (cyan), and K (black). The transfer unit 20 includes an endless intermediate transfer belt 6, a drive roller 22, a driven roller 23, a secondary transfer opposing roller 24, four primary transfer rollers 5Y, 5M, 5C, and 5K, and a secondary transfer roller 26. The endless intermediate transfer belt 6 serving as an image carrier is laid over the drive roller 22, the driven roller 23, and the secondary transfer opposing roller 24 so that the endless intermediate transfer belt 6 can be seen in an inverted triangle shape when viewed from one side.

The rotation drive from the drive roller 22 causes the intermediate transfer belt 6 to move endlessly clockwise as illustrated in FIG. 1. In the loop of the intermediate transfer belt 6, in addition to the drive roller 22, the driven roller 23, and the secondary transfer opposing roller 24, the four primary transfer rollers 5Y, 5M, 5C, and 5K are provided. The roles of the primary transfer rollers 5Y, 5M, 5C, and 5K and the secondary transfer roller 26 will be described below. The alphabets Y, M, C, and K will be omitted when a description is given using the general term and thus are represented only when they are described according to each color.

The tandem image forming unit 10 is provided above the transfer unit 20 such that the four image forming units 1 are arranged horizontally along the upper extended surface of the intermediate transfer belt 6. The image forming units 1 include drum-shaped photosensitive elements 2 that are driven to rotate anticlockwise as illustrated in FIG. 1, developing units 4, and charging units 3. Although it is not illustrated in FIG. 1, the tandem image forming units 10 include drum cleaning devices (not illustrated) for Y, M, C, and K. Each of the photosensitive elements 2 is driven by a drive unit so as to rotate anticlockwise as illustrated in FIG. 1 while making contact with the upper extended surface of the intermediate transfer belt 6 and thus forming a primary transfer nip. The developing units 4 develop electrostatic latent images formed on the photosensitive elements 2 by using toner in respective colors. The charging units 3 uniformly charges the surfaces of the photosensitive elements to the same polarity as that of the toner.

In the loop of the intermediate transfer belt 6 under the primary transfer nips, the primary transfer rollers 5 push the intermediate transfer belt 6 to the photosensitive elements 2. Primary transfer power units 11 apply primary bias to the primary transfer rollers 5. Above the tandem image forming units 10, optical writing units (not illustrated) are provided. The optical writing units perform optical writing processing using scanning light L on the surfaces of the photosensitive elements 2, which are uniformly charged by the charging units 3, to form static latent images.

The static latent images formed on the photosensitive elements 2 are developed by the developing units 4 into images in the respective colors. The toner images are, at the primary transfer nips, primarily transferred as superimposed on the surface of the intermediate transfer belt 6. Accordingly, superimposed toner images are formed on the surface of the intermediate transfer belt 6.

In Printer A, non-contact charging rollers 3 that are charged members to which a charging bias is applied by the charging bias power supply 34 are employed as charging units. The non-contact roller 3 causes electrification between the non-contact charging roller 3 and the photosensitive element 2 so as to uniformly charge the photosensitive element 2. Instead of such charging units (non-contact charging rollers), scorotron chargers, etc. may be employed.

The transfer unit 20 includes a secondary transfer roller 26 under the intermediate transfer belt 6. The secondary transfer roller 26 serving as a nip forming member makes, in a grounded state, a contact with the surface of the intermediate transfer belt 6 in the position where the intermediate transfer belt 6 is laid over the secondary transfer opposing roller 24, thereby a secondary transfer nip is formed. In contrast, above the secondary transfer nip, a secondary transfer bias power supply 14 applies a secondary transfer bias with the same polarity as the toner charge polarity to the secondary transfer opposing roller 24 over which the intermediate transfer belt 6 is stretched.

Accordingly, at the secondary transfer nip between the secondary transfer opposing roller 24 and the secondary transfer roller 26, a secondary transfer electric filed is formed that causes the toner to electrostatically move from the secondary transfer opposing roller 24 toward the secondary transfer roller 26. A recording sheet (not illustrated) is sent to the secondary nip at a given timing. The superimposed toner images of four colors on the intermediate transfer belt 6 are thus secondarily transferred to the recording sheet collectively from the effect of the nip pressure and the secondary transfer electric field. The recording sheet to which the superimposed toner images of four colors have been secondarily transferred exits the secondary transfer nip and is then sent into the fixing device 40 via a paper-sheet transfer belt 8 that is endlessly moved anticlockwise as illustrated in FIG. 1. In the fixing device 40, a process for fixing the toner images by pressure and heat processing is performed on the recording sheet between a heating fixing roller 41 including a heat source, such as a halogen lamp, and a pressure roller 42 that is pressed against the heating fixing roller 41.

The fixing device 40 takes on a role of, in addition to fixing the toner images onto the recording sheet as described above, drying the recording sheet as described below before the toner images are secondarily transferred onto the recording sheet.

An image is formed on the recording sheet on the side opposite to the side with the image that has been fixed by the fixing device 40. Specifically, when double-sided printing is performed, the re-transfer device 50 serves as a switch back mechanism (recording medium inversion device) 51 that guides the recording sheet transferred from the fixing device 40 by using a transfer guide 12 to a transfer route 17 and inverts the recording sheet. The recording sheet is turned upside down by the switch back transfer. The recording sheet is then re-transferred to the secondary transfer nip.

In contrast, when the recording sheet having no toner image is dried by the fixing device 40, the re-transfer device 50 guides the recording medium to a transfer route 16 by using the transfer guide 12 and retransfers the recording medium to the secondary transfer nip without turning it upside down. Two timing transfer rollers 13 correct the skew of the recording sheet in a way that the top of the paper sheet is butted against the rollers whose rotation is stopped. Thereafter, the two rollers are rotated to tuck the top of the recording sheet into the roller nip but the rotation of the rollers is soon after stopped. The rotation of the rollers is restarted at a timing such that the recording sheet can be synchronized with the toner images on the intermediate transfer belt 6 at the secondary transfer nip.

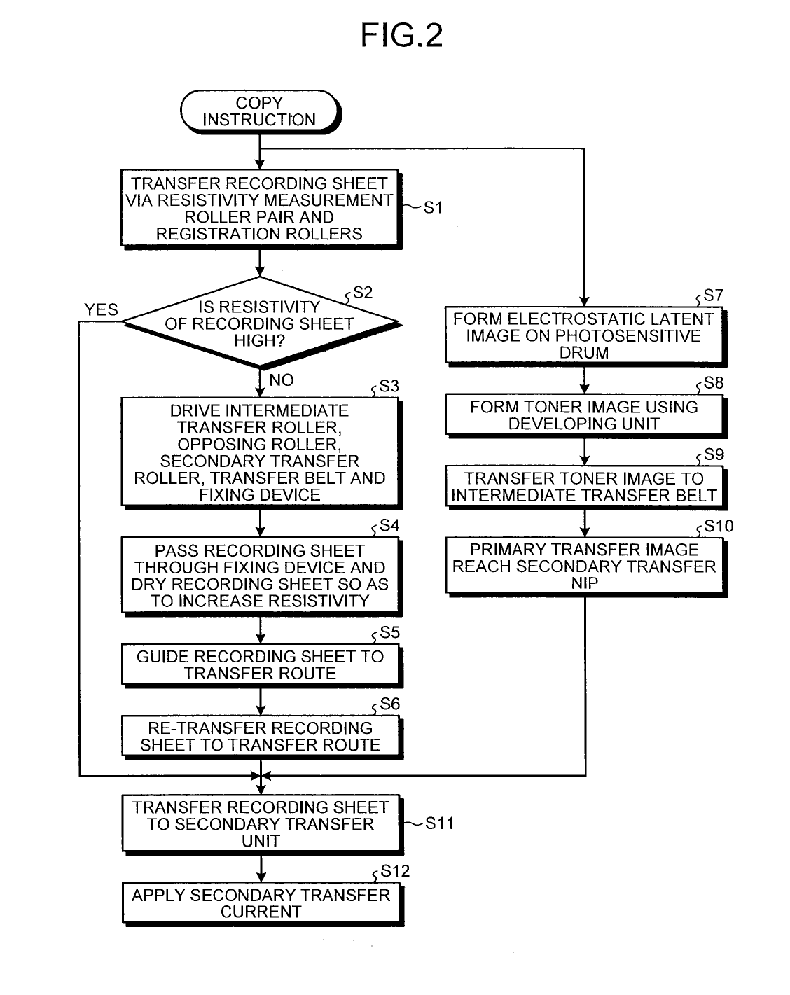

FIG. 2 is a flowchart indicating the flow of control where the present invention is carried out for the printer illustrated in FIG. 1. An image forming operation will be described with reference to FIGS. 1 and 2. In Printer A, when color image data occurs in a scanner etc., first, a recording sheet that is a recording medium, such as paper or an OHP sheet is fed. The recording medium feeding is performed by transferring it from the paper feeding cassette (not illustrated) serving as a recording medium feeding device via a resistance measurement roller pair 31 and the timing transfer rollers 13 (step S1). If the recording sheet is paper, it is determined whether the resistivity of the paper is high (step S2).

When, for example, the humidity is high exceeding 50%, it is determined, depending on the paper type, that the resistivity is low (for example, the volume resistivity is 1.0×10⁹ [Ω·CM] or smaller). When it is determined that the paper resistivity is low, the intermediate transfer belt 6, the secondary transfer opposing roller 24, the secondary transfer roller 26, the paper-sheet transfer belt 8, the fixing device 40 illustrated in FIG. 1, etc., are driven (step S3) and the paper is passed through the fixing device 40 to be dried in order to increase the resistivity of the paper (step S4). The paper having passed through the fixing device 40 is guided to the transfer route 16 (step S5) and then re-transferred to the timing rollers 13 (step S6). In this case, using the fixing device 40 as a recording medium resistivity increasing unit that increases the paper resistivity before secondary transfer assuredly increases the paper resistivity without any extra mechanism or device.

In contrast, in parallel with the paper drying by the fixing device 40, in the image forming unit 1Y of the tandem image forming unit 10, first, the non-contact charging roller 3 that has been negatively biased by the power supply negatively charges the photosensitive drum 2Y uniformly. An exposing device (not illustrated) then forms a electrostatic latent image on the surface of the photosensitive drum 2Y (step S7).

A developing unit 4Y then performs reversal development on the toner with the negative charge so as to form a toner image on the photosensitive drum 2Y (step S8). A positive bias that is opposite polarity to the toner polarity is applied to the primary transfer roller 5Y and the transfer magnetic field that is formed between the photosensitive drum 2Y and the primary transfer roller 5Y causes the toner image on the photosensitive drum 2Y to be transferred onto the intermediate transfer belt 6 (step S9) so that a primary transfer image is formed. Similarly, image forming is carried out in the primary transfer image forming units 1M, 1C, and 1K in accordance with respective timings so that a primary transfer image consisting of toner of four colors is formed on the intermediate transfer belt 6.

In accordance with the timing at which the primary transfer image reaches the secondary transfer nip part (step S10), the recording sheet whose resistivity has been increased at step S4 is transferred from the timing transfer rollers 13 to the secondary transfer nip that is formed by the intermediate transfer belt 6 and the secondary transfer roller 26 (step S11).

A current with the same polarity as the toner polarity is applied to the secondary transfer opposing roller 24 (step S12). The value of the secondary transfer current is controlled on a pixel-by-pixel basis in the sub-scanning direction in accordance with the value calculated by Equation 1, based on the coverage rate in the main-scanning direction of the toner image at the secondary transfer nip exit part and the estimated value of the amount of charge of the toner:

I=A×Σ(ηᵢ×Qᵢ)+B (1)

where I is a secondary transfer current value [μA], A and B are constants, ηᵢ is a coverage rate of each color, and Qᵢ is the amount of charge of the toner of each color (μC/g).

This control is performed such that the secondary current value applied to the secondary transfer roller 26, serving as a conductive member, or the secondary transfer opposing roller 24, serving as an opposing member, increases in accordance with an increase in the amount of charge of the toner on the intermediate transfer belt 6, serving as an intermediate transfer member. Accurately determining and controlling the optimum secondary transfer current in consideration for the coverage rate of the toner to be transferred and the amount of charge of the toner leads to constant uniform transfer. The embodiment depicted in FIG. 1 employs the fixing device 40 as the recording medium resistivity increasing unit that increases the paper resistivity, which is a recording medium, before secondary transfer and utilizes the heat from the fixing device 40, but the recording medium resistivity increasing unit is not limited to this.

For example, a contact/non-contact mechanism for heating the paper may be provided between the timing transfer roller 13 and the secondary transfer nip. Alternatively, dehumidification may be performed by constantly drying the paper in the paper feeding tray or by using a dehumidifier.

Here, the most simple configuration, i.e., a configuration where the value of the secondary transfer current is obtained by using Equation (1), is used to give descriptions corresponding to the above-described FF control system output. When an equation that leads to the secondary transfer current value is obtained, an equation is configured by, for example, making much account not particularly on the dynamics according to the amount of charge of the toner but on the dynamics according to environmental changes from a thermo-hygrometer etc. In this manner, an FF control system for determining a valid secondary transfer current value with respect to various dynamics can be configured.

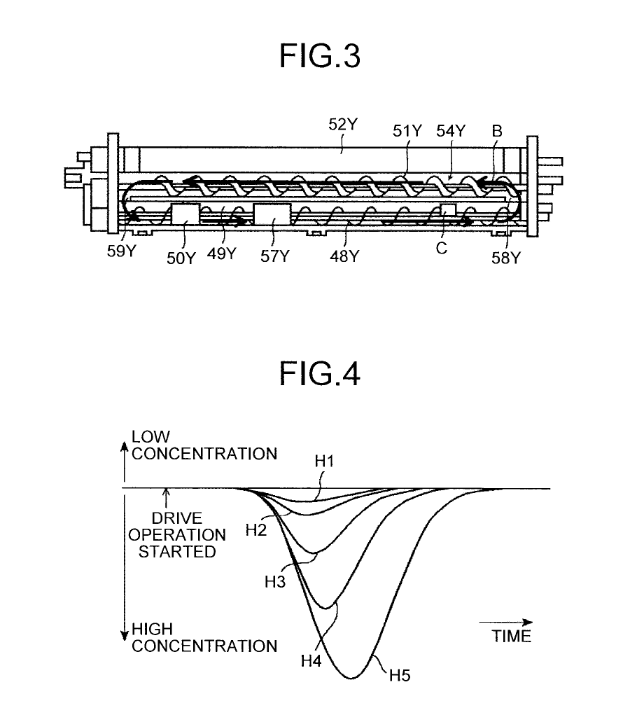

FIG. 3 depicts a developing unit configuration in the vicinity of a developer circulation route in which a developer consisting of two components circulates in a developing unit.

As illustrated in FIG. 3, the developing unit 4Y serving as a developing unit includes a first developer storage unit 49Y that is provided with a first transfer screw 48Y serving as a developer transfer unit. The developing unit 4Y further includes a toner concentration sensor 50Y consisting of a magnetic permeability sensor and serving as a toner concentration detector, a second transfer screw 51Y serving as the developer transfer unit, a developing roller 52Y serving as a developer carrier, and a second developer storage unit 54Y that is provided with a doctor blade (not illustrated) as a developer adjusting member. These two developer storage units stores a Y developer (not illustrated) that is a two-component developer consisting of magnetic carriers and negatively-charged Y toner. The first transfer screw 48Y is driven to rotate by a drive unit (not illustrated) so that the Y developer in the first developer storage unit 49Y is transferred in the direction indicated by the arrow B illustrated in FIG. 3. Regarding the Y developer being transferred, the toner concentration sensor 50Y fixed to the first transfer screw 48Y detects the toner concentration of the Y developer passing through the upstream position in the developer circulation direction with respect to the position opposed to a toner supply port 57Y in the first developer storage unit 49Y (hereinafter, “supply position”). The Y developer having been transferred by the first transfer screw 48Y to the end of the first developer storage unit 49Y then enters the second developer storage unit 54Y via a communication port 58Y. The symbol C illustrated in FIG. 3 indicates where the toner concentration is measured.

The second transfer screw 51Y in the second developer storage unit 54Y is driven to rotate by a drive unit (not illustrated) and thus transfers the Y developer to the direction indicated by the arrow B illustrated in FIG. 3. The second transfer screw 51Y that transfers the Y developer as described above is provided with the developing roller 52Y parallel to the second transfer screw 51Y. The developing roller 52Y is configured to include a magnet roller (not illustrated) that is arranged as fixed in a developing sleeve (not illustrated) consisting of a non-magnetic sleeve that is driven to rotate anti-clockwise. The Y developer transferred by the second transfer screw 51Y is partly lifted up to the surface of the developing sleeve by the magnetic force of the magnet roller. After the thickness of the Y developer is adjusted by the doctor blade provided to keep a given gap between the doctor blade and the developing sleeve, the Y developer is transferred to a developing area opposed to the photosensitive element 3Y and the Y toner is caused to adhere to the Y electrostatic latent image on the photosensitive element 3Y so that a Y toner image is formed on the photosensitive element 3Y. The Y developer whose Y toner has been consumed for the development is then returned to the second transfer screw 51Y according to the rotation of the developing sleeve. The Y developer having transferred by the second transfer screw 51Y to the end of the second developer storage unit 54Y then returns to the first developer storage unit 49Y via a communication port 59Y. In this manner, the Y developer circulates in the developing unit.

FIG. 4 is a graph indicating supply basic patterns for a toner supply device. The waveforms H1, H2, H3, H4, and H5 are waveforms respectively indicating the results of detection of variations in the toner concentration over time performed by a measurement sensor at the measurement position B when the Y developer without toner concentration unevenness is supplied with toner in five supply patterns in each of which a different amount of toner is supplied in one drive operation performed by a drive source (hereinafter, “supply basis waveforms”). The unit supply amount increases in the ascending order of the supply basic waveforms H1, H2, H3, H4 and H5. The supply amount in one time can be varied by changing the drive time and drive speed for the drive source during the supply operation for one time.

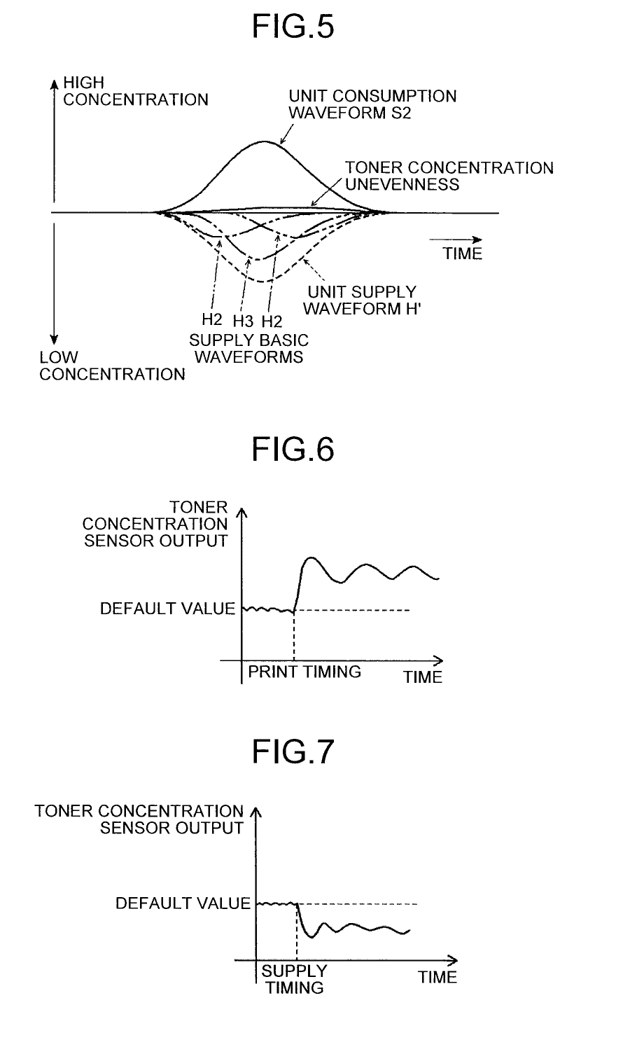

FIG. 5 is a graph illustrating how to cancel unevenness in the toner concentration by using the supply basic waveforms for a unit consumption waveform S2 that occurs due to some image output. From the unit consumption waveform S2 and the supply basic waveforms H1, H2, H3, H4 and H5, a unit supply waveform H′ that cancels the unit consumption waveform S2 is created by using multiple supply basic waveforms H2 and H3 at various times. A combination of the unit consumption waveform S2 and the unit supply waveform H′ results in small residual toner concentration unevenness and thus the toner concentration can be kept constant. This logic can be applied to all images to be printed and, by using proper combinations among supply basic waveforms H1, H2, H3, H4 and H5, at least the toner concentration unevenness of the Y developer having passed through the measurement position C illustrated in FIG. 3 can be canceled. In other words, before depending on the developing function, the toner concentration unevenness can be canceled.

The waveform patterns using the supply basic waveforms H1, H2, H3, H4 and H5 are used to simply describe the concept, and this part corresponds to the above-described output of the FF control system that performs prediction control. When supply basic waveforms are obtained, here, they are constructed on the basis of the dynamics of toner consumption for image printing and effects of the amount of charge of toner and effects of variations in the temperature and humidity are incorporated as dynamics. By using them, an FF control system can be constructed that determines a valid toner supply amount with respect to various dynamics.

A specific method of constructing an FF control system will be described below.

The input of the FF control system for toner concentration control is pixel data and the output is a necessary toner supply amount or a toner supply time period. The output differs depending on whether only the necessary amount of toner is output or whether the toner supply time period, for which it is taken into account that the toner will be thereafter passed to the toner supply drive mechanism, is output.

The purpose of the FF control system is to keep the toner concentration constant. Thus, first, for a developing unit to which toner is not supplied, toner concentration variations are detected by using the toner concentration sensor in all patterns with various image area rates. FIG. 6 indicates the behavior of the toner concentration sensor output.

It is necessary to offset the toner concentration variations due to toner consumption with the toner concentration variations due to toner supply that are output by the FF control system. Thus, similarly, for a developing unit that does not consume toner, the toner concentration variations are detected by using the toner concentration sensor in all patterns with various toner supply amounts or toner supply time periods. FIG. 7 indicates the behavior of the toner concentration sensor output.

An FF control system is constructed that keeps the toner concentration constant by offsetting the toner concentration variations during toner consumption with the toner concentration variations during toner supply. The size of peaks or valleys and the undulating shape are different between toner consumption and toner supply. Because the peaks and undulation for toner consumption cannot be changed basically, the depth of valleys caused by toner supply is changed by increasing the toner supply amount, by increasing the toner supply time period, by increasing the number of toner supply instructions, or by increasing the number of toner supply instructions for increasing the toner supply time periods and for increasing the number of toner supply timings.

This FF control system may employ various types of methods including a method where patterns with various image area ratios are stored in a table, a method where only a pattern of a reference image area ratio is stored and a gain is obtained by multiplication in accordance with the deviation of the input image area ratio, and a method where it is replaced by an equation or filter, stored, and configured. Here the designer may determine by which degree the toner consumption or toner supply amount is changed or the resolution and all measured patterns are not necessarily used.

Accordingly, without performing any supply operation to increase the toner concentration or any negative operation to reduce the toner concentration, for example, physically meaningful correction control can be performed with respect to the terms specific to the toner concentration control, e.g. a stand-by state is kept until the image is output or, although it is not preferable, the toner is positively consumed. Such construction of an FF control system without data offset processing leads to preferable control on the toner concentration without any error.

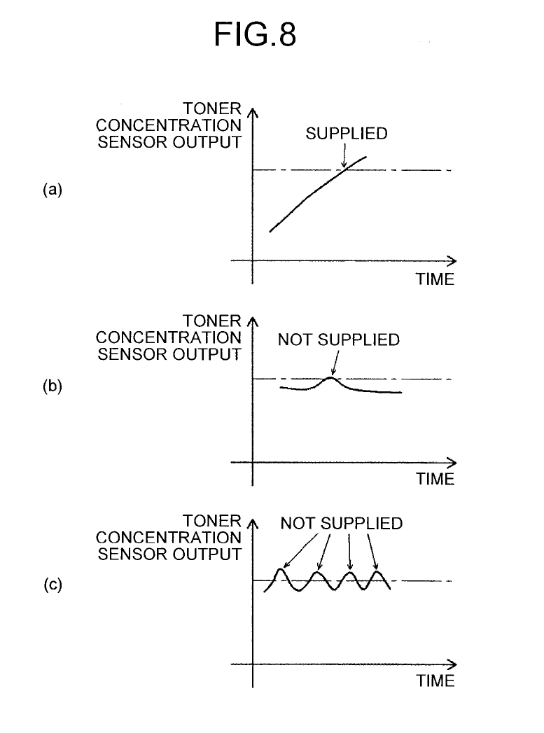

If removal of offsets is forced, the boarder between where supply starts and where consumption starts is fixed by a certain value. However, real toner concentration control has a complicated configuration where the supply or consumption timing or the threshold varies depending on the operation time period or the area rate of an image to be printed. For example, even when the toner concentration is constant, as illustrated in (a) of FIG. 8, toner is supplied if the toner concentration successively increases for an arbitrary time period. However, as illustrated in (b) and (c) of FIG. 8, toner is not supplied when instantaneous or intermittent increase and decrease in the toner concentration repeats. Even for such complication, optimum designing can be done by keeping information by leaving offsets.

For such variations, for example, a supply operation is added if the toner concentration sensor output had monotonically increased, i.e., if the toner concentration had continued decreasing, for a past arbitrary time period, or it is determined that the toner concentration is at a threshold for supply and consumption, i.e., at a target toner concentration value.

This correction control can be also implemented by FB control where a threshold is used as a target value and the toner concentration sensor output is used as a feedback and is compared with the target value. However, once FB control is constructed, because only two types of determinations are made to supply toner when the threshold is exceeded even slightly and not to supply toner when the threshold is not exceeded, it fluctuates in the vicinity of the threshold. Furthermore, there exists a time lag referred to as “dead time” between when the toner concentration is detected by the toner concentration sensor output and when toner is actually supplied and the toner concentration sensor detects it. This time lag may increase the fluctuations in the vicinity of the threshold.

In contrast, if additional correction control is performed in the FF control system, the FF control system reduces basic toner concentration variations. A part where the variations cannot be removed completely is finely adjusted according to the tendency in the toner concentration sensor outputs so that it can be close to the target toner concentration by correction control. Adding the correction control that brings the toner concentration to a target value based on the variation amount further improves the FF control system performance.

In the above descriptions, consumption and negative supply are treated as the same, but, actually, supply is carried out at a point in the developing device and consumption is carried out in a line or plane occurring in printing. Accordingly, the problem can be solved in that, while consumption and negative supply are treated as the same mathematically, the behaviors of point, line, and plane are different physically.

A stuck toner control will be described. In the stuck toner control, the LD power and developing bias values are adjusted such that the amount of toner stuck to a photosensitive element or the intermediate transfer belt is a preferable value.

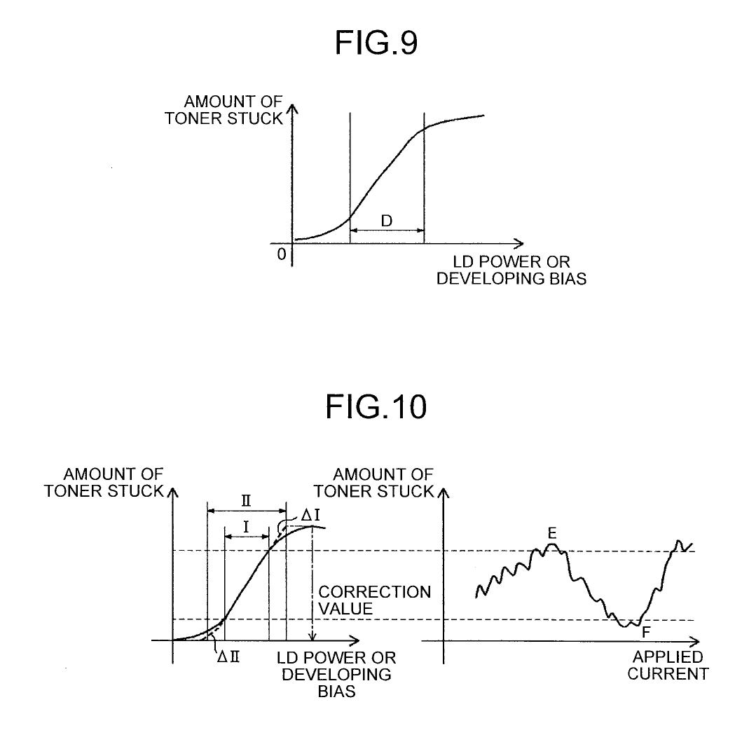

Basically, a section indicating linearly characteristics is used for the values of the LD power and the developing bias with respect to the amount of toner stuck. However, a small part of non-linear characteristics have an effect on obtaining high quality images. Such characteristics will be described briefly. From a larger view, the amount of toner stuck has the correlation like that illustrated in FIG. 9 with respect to the LD power value or the developing bias value.

In real products, correction control is performed by using only the part corresponding to Section D that seems to have approximately linear characteristics to guide the relationship between the LD power or the developing bias and the amount of toner stuck. However, strictly, even Section D does not show a linear relationship but has non-linear characteristics in a shape close to S similar to the whole shape. In other words, the correlation is disordered in the vicinity of upper and lower limits. In real products, then the value gets close to the upper or lower limit, a limitation is put forcibly or an adjustment mode that is a different operation is entered to shift the value to the center part of the correlation. If successive outputs are made during that, this results in a problem in that the tone etc. differs slightly even between prints of the same type.

As in the case of the toner concentration control, the stuck toner control is also preferably configured by using an FF control system, because, mainly using an FB control system that performs corrections after deviation occurs results in a problem in that correction control is not performed until deviation occurs and accordingly, during that time, the image quality lowers.

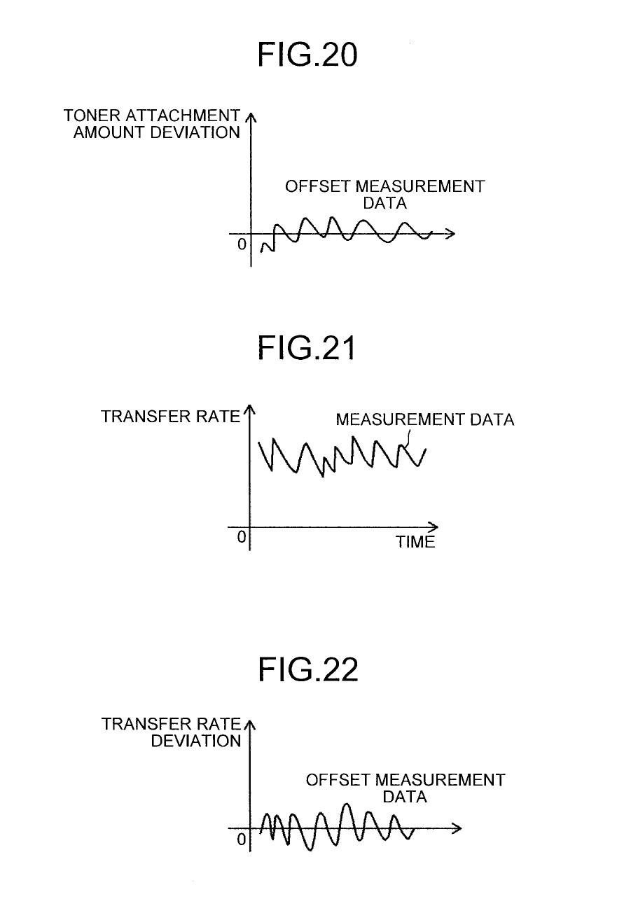

If an FF control system is constructed by using offset measurement data like that illustrated in FIG. 20 for the toner stuck measurement data like that illustrated in FIG. 19, the system is constructed in accordance with the previously-shown Section D with the preferable correlation. Obviously, this still allows the minimum operations, but if high-quality images are targeted as described above, different characteristics are shown in the vicinity of the upper and lower limits and accordingly images in sufficient quality cannot be obtained.

If an FF control system is constructed by using the measurement data that has not been offset, there is no liner relationship in the vicinity of upper and lower limits and thus correction control is constructed covering the vicinity of the upper and lower limits. Thus, a correction control system can be constructed specifically considering the relationship between the LD power or the developing bias and the amount of toner stuck.

For example, the following situation will be assumed.

FIG. 10 indicates the correlation between the amount of toner stuck and the LD power or the developing bias. While Section I has a small deviation and thus can be considered as an almost linear section, it is assumed that the range of values that can be taken for the real product is Section II. While the right graph in FIG. 10 has the same vertical axis as that of the left graph, its horizontal axis indicates measurement data obtained by actual measurement.

For example, at E, a deviation corresponding to the value of ΔI occurs with respect to a correction amount necessary for the linear relationship. In contrast, if it is recognized, from the value, that there is a deviation on the upper limit side in Section I, additionally applying the LD power or the developing bias only for the shortage corresponding to ΔI can lead to a preferable amount of toner stuck. Here, the correction indicated by the dashed line illustrated in FIG. 10 is carried out and, by inputting the correct correction value, preferable amount of toner stuck can be acquired. It is satisfactory if an FF control system using that amount as a command value be constructed.

Similarly, at F, a deviation corresponding to the value for ΔII occurs. Reducing the LD power or the developing bias only for the surplus corresponding to ΔII can lead to a preferable amount of toner stuck, which is not illustrated in the drawings.

Regarding the above discussion, if offsets are removed mechanically, it cannot be specified at all which part of Section I corresponds to the center value that is “0”, which makes it difficult to perform the above-described correction. In order to avoid this, it is required to construct a control system by using the original values without removing offsets.

A part having a linear relationship and a part having a non-linear relationship in a section have been described separately above. There are many other constructing methods using, for example, a non-linear control theory, multiple dimensions for curve fitting, etc.

Specific FF control system constructing methods will be described.

Inputs of an FF control system for stuck toner control are pixel data and FF control system outputs are ±(plus-minus) correction amounts necessary for the LD power and developing bias. The outputs may be, depending on the configuration, only for the LD power or the developing bias and, alternatively, a configuration may be employed where a combination thereof or one of them is prioritized.

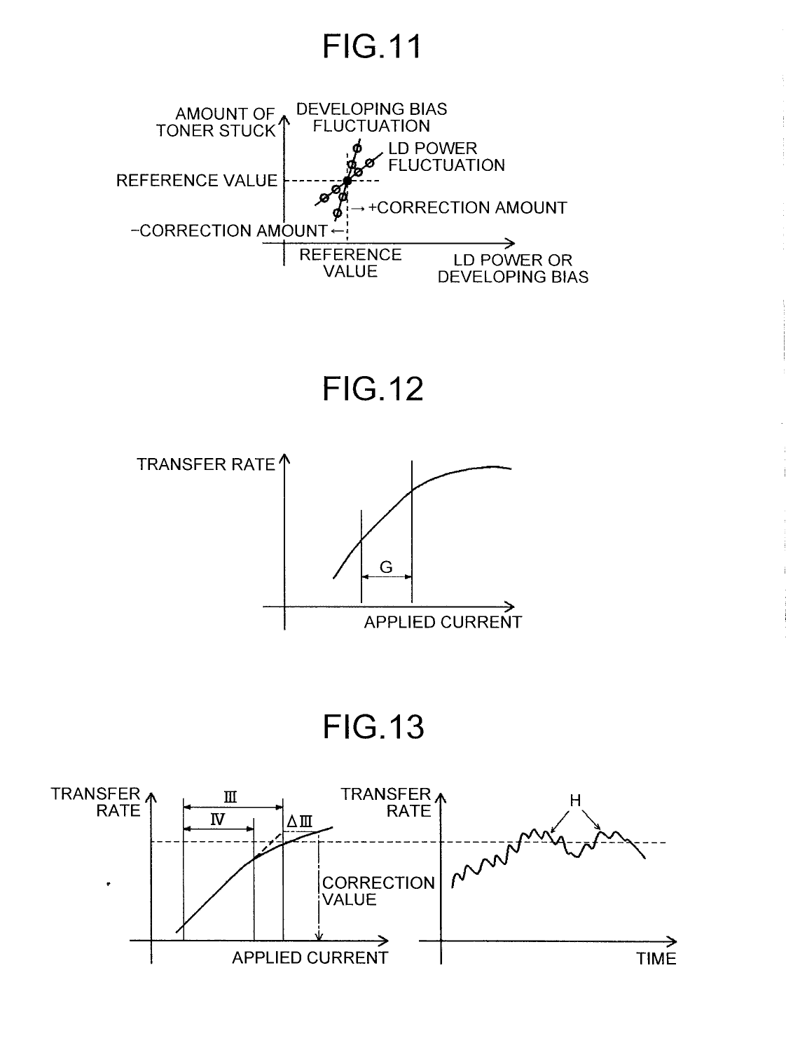

Because the purpose of the FF control system is to have the amount of toner stuck at a targeted value, all patterns are created where, first, the amount of toner stuck is varied according to the reference values of the LD power and developing bias. The relationship between a certain amount of toner stuck, the LD power, and the developing bias is illustrated in FIG. 11.

In an ideal state, with the LD power and developing bias at the reference values, as indicated by the black bullet, the amount of toner stuck is at the reference value. In contrast, as indicated in FIG. 11, the value of amount of toner stuck that varies as the developing bias fluctuates and the value of amount of toner stuck that varies as the LD power fluctuates are acquired. Thus, the correlation specifying how the amount of toner stuck varies and how much fluctuations in the develop bias and LD power are necessary for such variations can be obtained. From the correlation, a plus (+) correction amount for increasing the amount of toner stuck and a minus (−) correction amount for reducing the amount of toner stuck can be obtained and accordingly an FF control system that corrects the deviation described above as the problem can be constructed. A combination of LD power and developing bias may be used to determine a correction amount.

Although the linear correlation has been described, the same approach can be applied even to non-linear correlation.

Because pixel information determines the amount of toner stuck and the value of the amount of toner stuck varies, what described above is preferably performed with respect to various amounts of toner stuck. However, it is time-consuming and, for this reason, it may be omitted for intermediate amounts of toner stuck having approximately linear characteristics as shown in Section I in FIG. 10 used to describe the problem, and, furthermore, it may be omitted for lower amounts of toner stuck because it is difficult to perceive by human visual perception.

Furthermore, it is more preferable to regularly update the FF control system designed here, because there are complex factors, including the operating environment and the degree of degradation of parts in addition to mechanical individual variability, that determines the amount of toner stuck. Alternatively, mechanical automatic correction may be employed or users may manually make corrections. This allows the user to have preferred gradations flexibly. Such construction of an FF control system without data offset processing leads to preferable control on the amount of toner stuck.

A transfer current control will be described below. In the transfer current control, a current to be applied is controlled such that the transfer rate that varies depending on the image area rate, the transfer paper size, and the paper type (unevenness) will not change.

Using the image area rate, it will be described why it is necessary to control the applied current. Because the image quality lowers if the same transfer rate is not used even for an almost blank print with a lower image area rate or a print, such as a solid image, with a lower image area rate, it is necessary to keep the electric field at a constant value. However, for a solid image, because there is a large volume of toner on the photosensitive element and the toner charge electric potential has large effects at few tens of volts. In contrast, for an almost blank image, there is little toner and thus the toner charge electric potential has large effects at few hundreds of volts. Even for such a potential difference, because it is required to create the same electric field, the same electric field is created by varying the current to be applied for transfer current and to keep the transfer rate constant for any image.

This also applied to the paper type (unevenness) or the transfer paper size.

Basically, there is no difficulty if data under the same conditions is sequentially input during one job. However, if different conditions coexist, individual correction control is required and thus it is preferable to construct an FF control system because FB control cannot deal with it.

However, the transfer rate and applied current have the following correlation where small non-linearly characteristics have effects when high-quality images are targeted.

In real products, correction control is performed where only the part of Section G illustrated in FIG. 12 that seems to be approximately linear characteristics is used to determine the value of a current to be applied.

However, specifically, even Section G has characteristics where it saturates as, particularly, the applied current increases. Thus, there is a problem in that the target transfer rate value cannot be obtained if the applied current increases, which have effects on the image quality.

If an FF control system is constructed by using offset measurement data like that illustrated in FIG. 22 for the transfer rate measurement data like that illustrated in FIG. 21, the system is constructed in accordance with the previously-shown Section D with the preferable correlation. Obviously, this still allows the minimum operations but do not satisfy the above-described high-quality images.

If an FF control system is constructed by using the measurement data that has not been offset, parts in the vicinity of the upper limits have no linear relationship and correction control is constructed covering the vicinity of the upper limits. Thus, a correction control system can be constructed specifically considering the relationship between the applied current and the transfer rate.

For example, the following situation will be assumed.

FIG. 13 is a graph indicating the correlation between the transfer rate and applied current. While Section IV has a small deviation and thus can be considered as an almost linear section, it is assumed that the range of values that can be taken for the real product is Section III. While the right graph of FIG. 13 has the same vertical axis as that of the left graph, its horizontal axis indicates measurement data obtained by actual measurement.

For example, at H, a deviation corresponding to the value of ΔIII occurs with respect to a correction amount necessary for the linear relationship. In contrast, if it is recognized, from the value, that there is a deviation on the upper limit side in Section III, making a correction as depicted by the dashed line so as to fix the deficit corresponding to ΔIII and adding the necessary applied current can lead to a preferable transfer rate.

Regarding the above discussion, if offsets are removed mechanically, it cannot be specified at all which part of Section III corresponds to the center value that is “0”, which makes it difficult to perform the above-described correction. In order to avoid this, it is required to construct a control system by using the original values without removing offsets.

A part having a linear relationship and a part having a non-linear relationship in a section have been described separately above. There are many other constructing methods using, for example, a non-linear control theory, multiple dimensions for curve fitting, etc.

Specific FF control system constructing methods will be described.

In transfer current control, FF control system inputs are pixel data and paper information (paper unevenness or the paper size) and FF control system outputs are plus-minus (±) correction amount for the applied current. For inputs, a plus-minus (±) correction value for the applied current calculated from the image data and a plus-minus (±) correction value for the applied current calculated from paper information may be separated and, alternatively, a configuration may be employed where a combination thereof or one of them is prioritized.

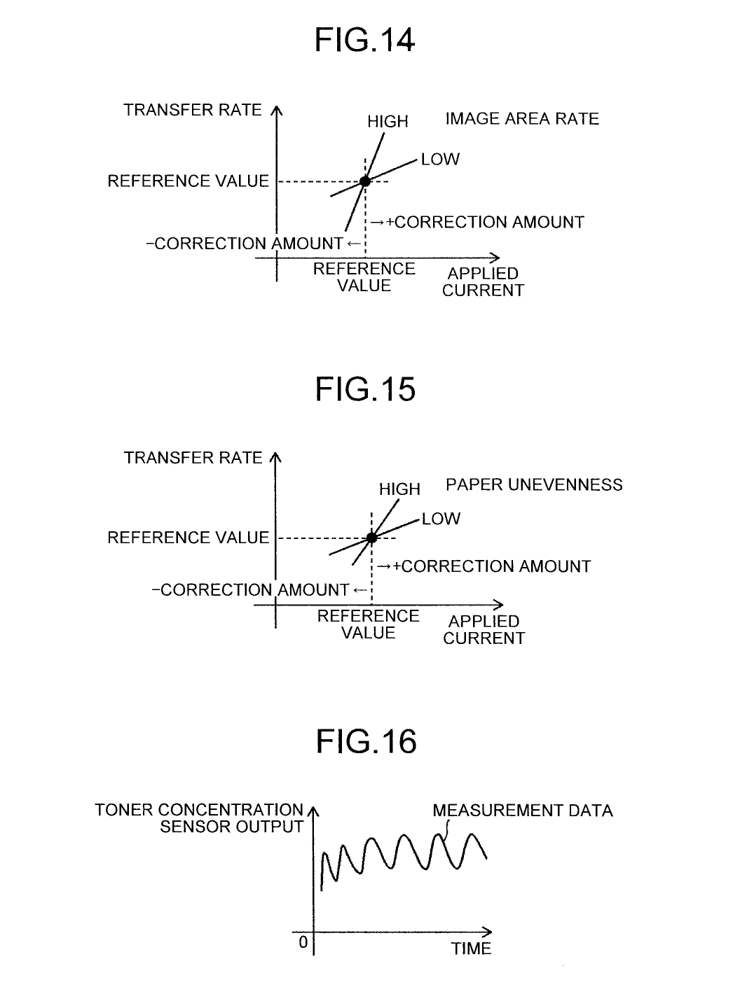

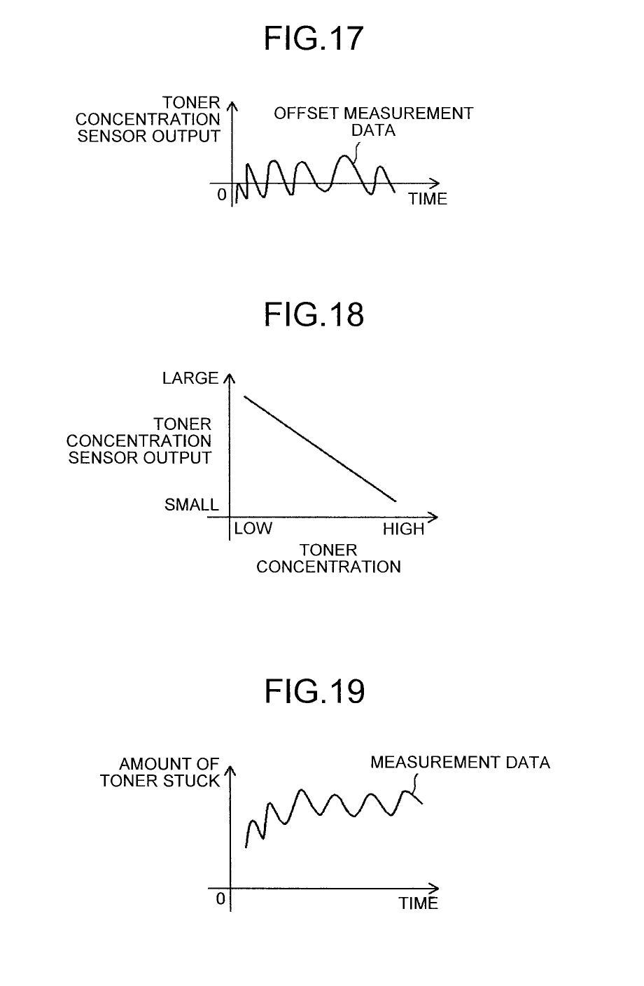

Because the purpose of the FF control system is to keep the transfer rate at a target constant value, all patterns are created where, first, the transfer rate and the e image area ratio are varied according to the reference value of the applied current value. The relationship between a certain transfer rate and the applied current is illustrated in FIG. 14.

In an ideal state, with the reference applied current value, as indicated by the black bullet, the transfer rate is at the reference value. In contrast, as indicated in FIG. 14, the value of transfer rate that varies for each image area ratio as the applied current fluctuates is acquired. Here, the correlation specifying how the transfer rate varies and how much fluctuations in the applied current are necessary for such variations can be obtained in accordance with the image area ratio. From the correlation, a plus (+) correction amount for increasing the transfer rate and a minus (−) correction amount for reducing the transfer rate can be obtained and accordingly an FF control system that corrects the deviation described above as the problem can be constructed.

Similarly, all patterns are created where the transfer rate and paper unevenness are varied according to the reference value of the applied current value. The relationship between a certain transfer rate and the applied current is illustrated in FIG. 15.

In an ideal state, with the reference applied current value, as indicated by the black bullet, the transfer rate is at the reference value. In contrast, as indicated in FIG. 15, the value of transfer rate that varies for each degree of unevenness as the applied current fluctuates is acquired. Here, the correlation specifying how the transfer rate varies and how much fluctuations in the applied current are necessary for such variations can be obtained for each level of unevenness. From the correlation, a plus (+) correction amount for increasing the transfer rate and a minus (−) correction amount for reducing the transfer rate can be obtained and accordingly an FF control system that corrects the deviation described above as the problem can be constructed. Such construction of an FF control system without data offset processing leads to control on transfer rate without any error.

A combination of image are ratio and paper unevenness may be used to determine a correction amount. Although the linear correlation has been described, the same approach can be applied even to no-linear correlation.

Because pixel information and paper unevenness determines the transfer rate and the value of a transfer rate varies, what described above is preferably performed with respect to various transfer rates, but it is time-consuming. For this reason, it may be omitted for an area whose transfer rate is lower than a certain transfer rate because it has approximately linear characteristics shown in Section IV in the drawing used to describe the problem.

Furthermore, it is more preferable to regularly update the FF control system designed here, because there are complex factors, including the operating environment and the degree of degradation of parts in addition to mechanical individual variability, that determines the amount of toner stuck. Alternatively, mechanical automatic correction may be employed or users may manually make corrections. This allows the user to have preferred gradations flexibly.

According to an aspect of the present invention, an FF control system, for which it is usually expected to perform offset processing, is constructed without performing offset processing, which leads to a preferable control method without any error in timing etc.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A correction control method comprising:
performing correction control to bring a control value to a target value or a change through a prediction control system that previously applies a predetermined amount of correction and a predetermined timing, wherein
the prediction control system is constructed without performing data offset processing for deriving the predetermined amount of correction and the predetermined timing.

2. The correction control method according to claim 1, wherein the correction control method is used for toner concentration control in an image forming apparatus in which a developer is supplied to a developing unit.

3. The correction control method according to claim 1, wherein the correction control method is used for toner stuck control for controlling an amount of toner that is stuck to an image carrier.

4. The correction control method according to claim 1, wherein the correction control method is used for transfer current control for controlling a transfer current such that a rate at which a toner image is transferred to a recording medium is constant.

5. An image forming apparatus, in which the correction control method according to claim 1 is performed.
